(19) United States
(12) Patent Application Publication
(10) Pub. No.: US 2009/0052072 A1
(43) Pub. Date: Feb. 26, 2009

(54) Facial Hair Grooming Mirror Apparatus

(76) Inventor: Joseph Egosi, Tarpon Springs, FL (US)

Correspondence Address: Maxey Law Offices, PLLC, 13630 58TH ST. NORTH, SUITE 101, CLEARWATER, FL, 33760, US

(21) Appl. No.: 11/843,751

(22) Filed: Aug. 23, 2007

(51) Int. Cl. G02B 5/08; G02B 7/182

(52) U.S. Cl. 359/855; 359/871

(57) ABSTRACT

A facial hair grooming mirror apparatus for permitting a user to view an underside portion of the user's chin is provided. The mirror apparatus includes two mirror elements hingidly attached at adjacent edges for relative swinging between open positions where the reflective surfaces of the mirror elements form an angle and closed positions where the reflective surfaces are disposed parallel and juxtaposed. The mirror elements are attached to a base for rotation between a first configuration where the mirror elements are disposed generally horizontal and a second configuration where the mirror elements are disposed generally vertical. The base includes mounting members for removably attaching the mirror assembly to a support surface.

### BACKGROUND OF THE INVENTION

1. Field of the Invention

The present invention relates generally to certain new and useful improvements in facial hair grooming mirror apparatus, and more particularly, relating to an apparatus including two mirror members hingidly connected at adjacent marginal edge portions for swinging between open and closed positions with the reflective surfaces thereof facing each other, and which are rotatably attached to a base member for rotation between a first configuration where the reflective surfaces are disposed generally horizontal and a second configuration where the reflective surfaces are disposed generally vertical.

2. Description of the Related Art

The use of hair grooming mirrors is known in the prior art. More specifically, hair grooming mirrors heretofore devised and utilized are known to consist of expected, obvious, and familiar structural configurations, notwithstanding the wide variety of designs encompassed by the crowed prior art which have been developed for the fulfillment of a myriad of objects and requirements.

The disclosed facial hair grooming mirror apparatus is directed to overcoming one or more problems present in the art and to provide a facial hair grooming mirror apparatus that is especially suited for the shaving of a “Goatee” style beard.

### SUMMARY OF THE INVENTION

In general, in one aspect, a mirror apparatus for grooming facial hair enabling a user to view an underside portion of the user's chin when positioned in a first configuration, and enabling a user to view both side portions of a user's face when positioned in a second configuration, the mirror apparatus being compact, readily portable and removably attachable to a vertical surface, such as a bathroom mirror is provided. The mirror apparatus includes a base member having a longitudinal axis extending between opposed ends thereof. A first mirror member, the first mirror member having a reflective surface and a first marginal edge portion. A second mirror member, the second mirror member having a reflective surface and a first marginal edge portion. A coupling means for pivotally connecting the first marginal edge portions of the first and the second mirror members together for relative swinging between open positions with the reflective surfaces defining an angle therebetween and closed positions with the reflective surfaces disposed in a parallel and juxtapose relation. Rotation means for connecting the first and the second mirror members at first marginal edge portions to the base member for rotation about an axis normal to the longitudinal axis of the base member between a first configuration where the reflective surfaces are generally horizontal and a second configuration where the reflective surfaces are generally vertical. One or more attachment members for removably attaching the base member to a support surface, the attachment means connected to the base member.

In general, in another aspect, a mirror apparatus for grooming facial hair enabling a user to view an underside portion of the user's chin when positioned in a first configuration, and enabling a user to view both side portions of a user's face when positioned in a second configuration, the shaving mirror apparatus being compact, readily portable and removably attachable to a vertical surface, such as a bathroom mirror is provided. The mirror apparatus includes a base member having a longitudinal axis extending between opposed ends thereof. A coupling member. A first mirror member, the first mirror member having a reflective surface and a first marginal edge portion. A second mirror member, the second mirror member having a reflective surface and a first marginal edge portion. The first and the second mirror members are pivotally attached at the first marginal edge portions to the coupling member for relative swinging between open positions with the reflective surfaces defining an angle therebetween and closed positions with the reflective surfaces disposed in a parallel and juxtapose relation. The coupling member attached to the base member for rotation about an axis normal to the longitudinal axis of the base member between a first configuration where the reflective surfaces are positioned generally horizontal, and a second configuration where the reflective surfaces are positioned generally vertical. One or more attachment members for removably attaching the base member to a support surface, the one or more attachment members being attached to the base member.

In general, in another aspect, a mirror apparatus for grooming facial hair enabling a user to view an underside portion of the user's chin when positioned in a first configuration, and enabling a user to view both side portions of a user's face when positioned in a second configuration, the shaving mirror apparatus being compact, readily portable and removably attachable to a vertical surface, such as a bathroom mirror is provided. The mirror apparatus includes a base member having rearward facing surface, a forward facing surface, and a longitudinal axis extending between opposed ends thereof. A coupling member having opposed longitudinal edges. A first mirror member, the first mirror member having a reflective surface and a first marginal edge portion. A second mirror member, said second mirror member having a reflective surface and a first marginal edge portion. The first mirror member is pivotally attached at the first marginal edge portion thereof to a first longitudinal edge of the coupling member and the second mirror member is pivotally attached at the first marginal edge portion thereof to the opposite longitudinal edge of the coupling member for relative swinging between open positions with the reflective surfaces defining an angle therebetween and closed positions with the reflective surfaces disposed in a parallel and juxtapose relation. The coupling member attached to the forward facing surface of the base member for rotation about an axis normal to the longitudinal axis of the base member between a first configuration where the reflective surfaces are positioned generally horizontal, and a second configuration where the reflective surfaces are positioned generally vertical. one or more attachment members for removably attaching said base member to a support surface, said one or more attachment members being attached to said rearward facing surface of said base member.

In general, in another aspect, each of the first and the second mirror members define a housing, and the reflective surfaces are defined by mirror elements mounted within the housings with the reflective surfaces facing outwardly of the housings.

In general, in another aspect, the forward facing surface of the base member defines a post that projects outwardly therefrom along the axis normal to the longitudinal axis, and wherein a rearward facing surface of the coupling member defines a socket along the axis normal to said longitudinal axis and which rotating and captively receives the post so as to rotatably attach the coupling member to the base member.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other than those set forth above will become apparent when consideration is given to the following detailed description thereof Such description makes reference to the annexed drawings wherein:

FIG. 1 is a front perspective view of the facial hair grooming mirror apparatus constructed in accordance with the principles of the present invention shown in the first configuration with the mirror members disposed generally horizontal and position in an open position for viewing the underside portion of the user's chin;

FIG. 2 is a side elevation view of the facial hair grooming mirror apparatus in the first configuration with the mirror members positioned in a closed position;

FIG. 3 is a top plan view of the facial hair grooming mirror apparatus in the first configuration with the mirror members positioned in a closed position;

FIG. 4 is a side elevation view of the facial hair grooming mirror apparatus attached to a vertical support surface and in the first configuration with the mirror members disposed in an open position to view the underside portion of the user's chin;

FIG. 5 is a top plan view of the facial hair grooming mirror apparatus attached to a vertical support surface and in the second configuration with the mirror members disposed in an open position to view either side of the user's face;

FIG. 6 is a cross-sectional view taken along line 6-6 in FIG. 3 illustrating an exemplary construction a rotating connection between the coupling member and the base member; and

FIG. 7 is a cross-sectional view taken along line 7-7 in FIG. 6.

### DETAILED DESCRIPTION OF THE INVENTION

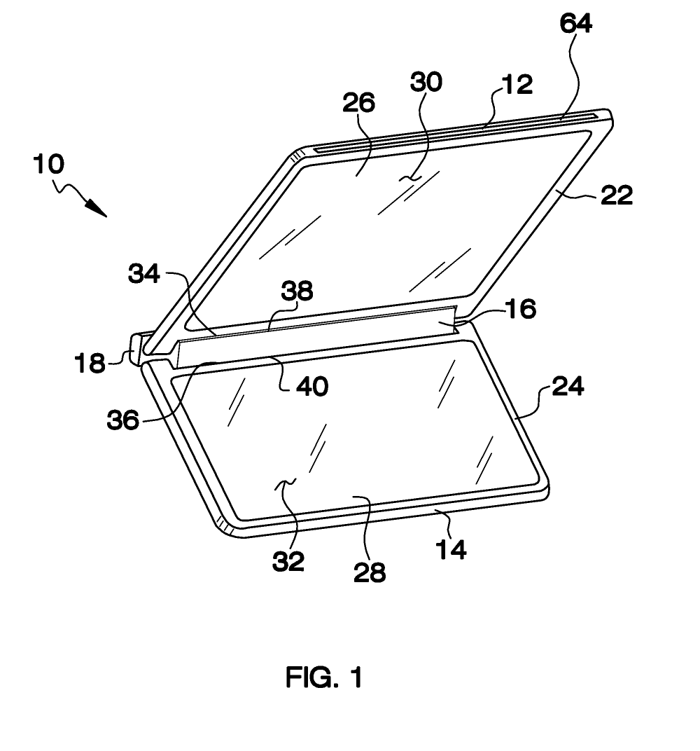

With reference to FIG. 1 of the drawings, there is shown a perspective view of a facial hair grooming mirror apparatus 10 for general use in grooming facial hair, and more specifically a goatee style beard that is constructed in accordance with the principals of the present invention. The mirror apparatus 10 is constructed to be readily portable and removably attachable to a vertical support surface without requiring a permanent installation. The mirror apparatus 10 is to aid a user in the trimming or otherwise grooming of facial hair, such as a goatee style beard. There exists a need for a user to be able to clearly view the hair line below the user's chin to properly trim the hair line or otherwise groom this portion of the beard while maintaining a general forward view. Heretofore, this portion of the beard was trimmed and/or groomed by the wearer tilting his head backward while looking downward to view the mirror positioned in front of him. This method is not desirable as tilting of the head backwards for an extended time to trim or/and groom this portion of the bread causes strain in the person's neck and eyes. Additionally, people with neck injuries very often are unable to tilt their head backwards for an extended time if at all. As such, the mirror apparatus 10 of the present invention provides an improved mirror apparatus which allows a user's to clearly view the portion of a beard below the user's chin while maintaining a forward view and without requiring the user to tilt his head backwards.

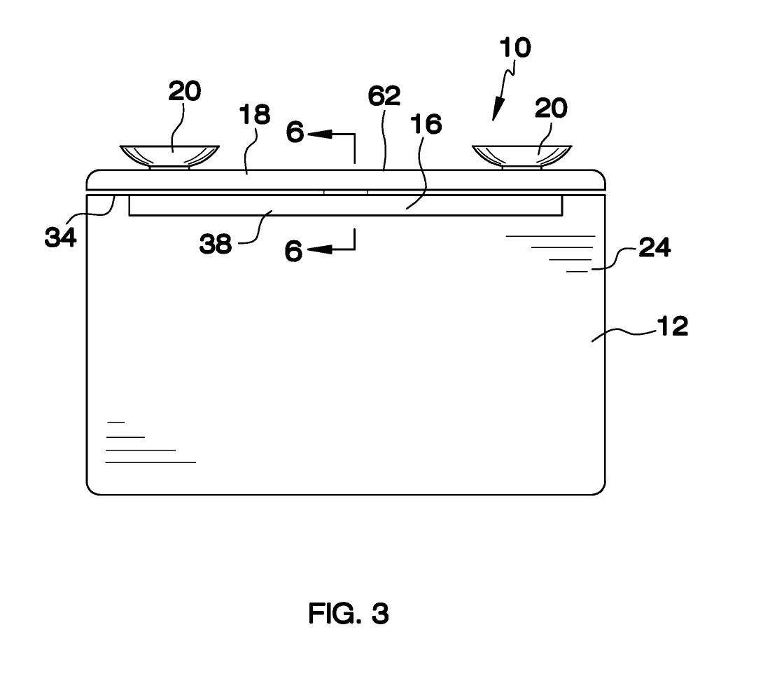

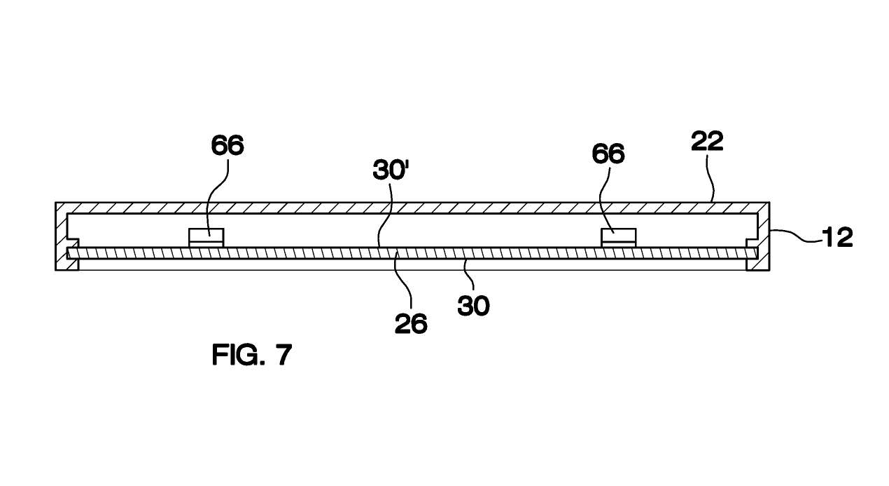

Now with reference to FIGS. 1-7, the mirror apparatus 10 includes a pair of mirror members 12 and 14, a coupling member 16, a base member 18, and one or more attachment members 20. The mirror members 12 and 14 include a housing 22 and 24 that supports a mirror element 26 and 28 having a reflective surface 30 and 32 respectively. One of the reflective surfaces 30, 32 may be magnifying.

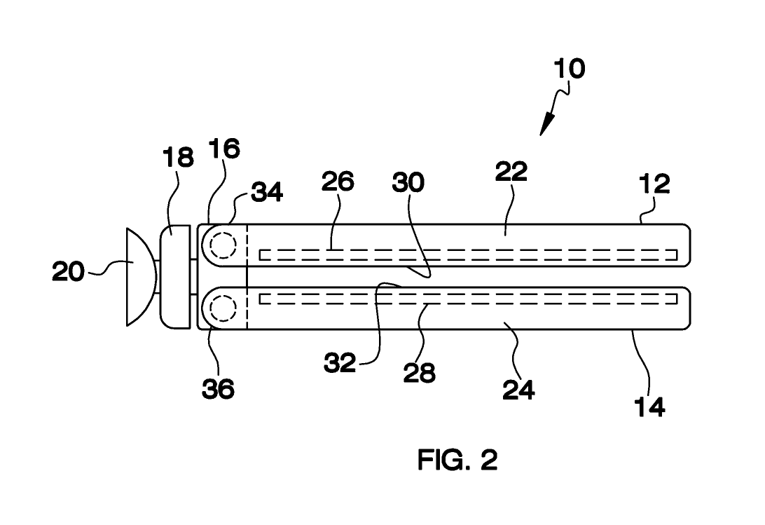

The mirror members 12 and 14 are hingidly connected together along adjacent first marginal edge portions 34 and 36 by a coupling member 16 for relative swinging between open positions, such as those illustrated in FIGS. 1, 4 and 5, where the reflective surfaces 30 and 32 form an acute angle therebetween and closed positions where the reflective surfaces are disposed parallel and juxtaposed, such as illustrated in FIG. 2. The first marginal edge portions 34 and 36 can be pivotally attached at opposed longitudinal edges 38 and 40 of the coupling member 16 respectively. The mirror members 12 and 14 each include a second marginal edge portion 13 and 15, which swing toward and away from each other mirror members are swung between the open and closed positions. The second marginal edge portions 13 and 15 are opposed the first marginal edge portions 12 and 14.

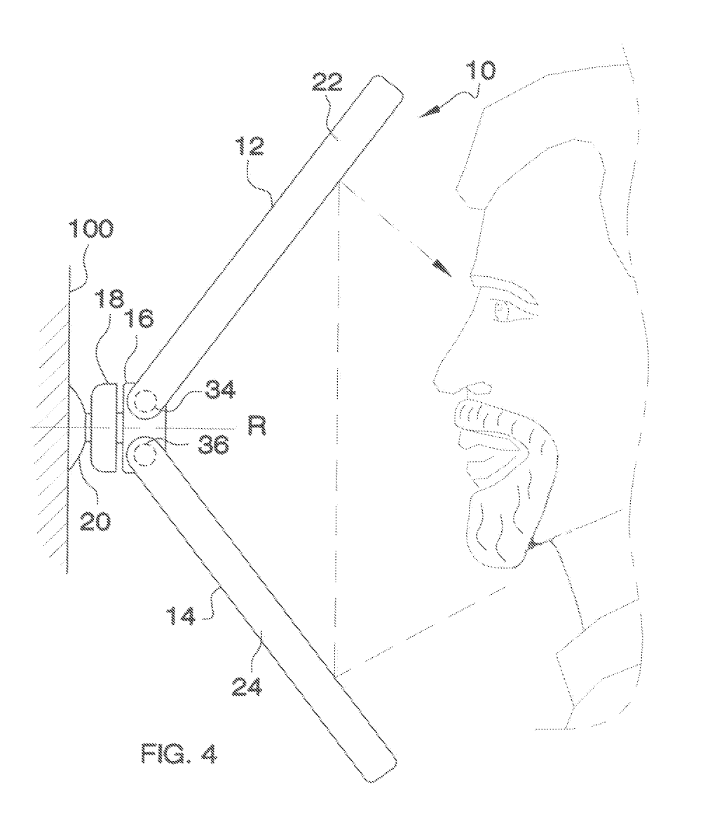

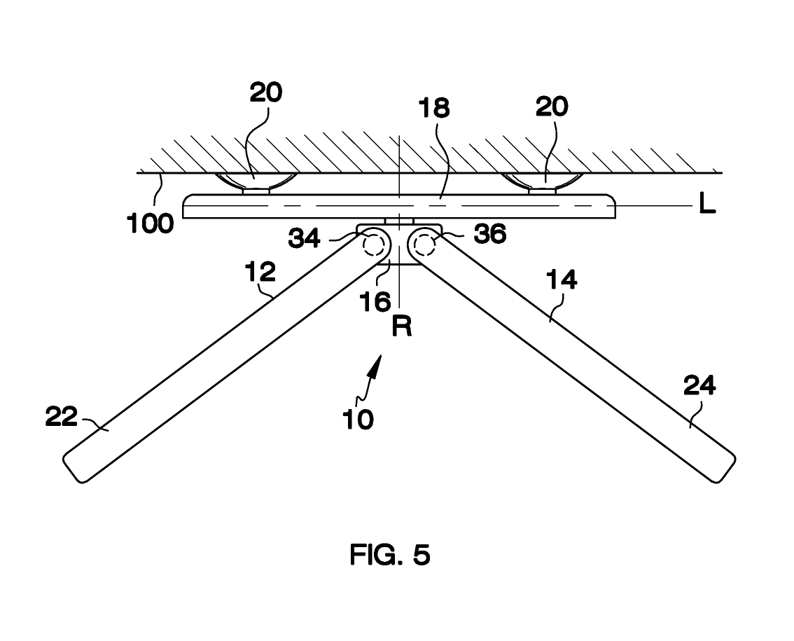

The coupling member 16 is attached to the base member 18 for 360-degree rotation about an axis of rotation designated as “R” that is generally normal to a support surface 100 and to a longitudinal axis “L” that extends between opposed ends 44 and 46 of the base member as best shown in FIGS. 4 and 5. The coupling member 16 being rotatably attached to the base member 18 permits the mirror members 12 and 14 to be rotated between a first configuration where the mirror members are disposed generally horizontal, as illustrated in FIGS. 1, 2 and 4, and a second configuration where the mirror members are disposed generally vertical, as illustrated in FIG. 5.

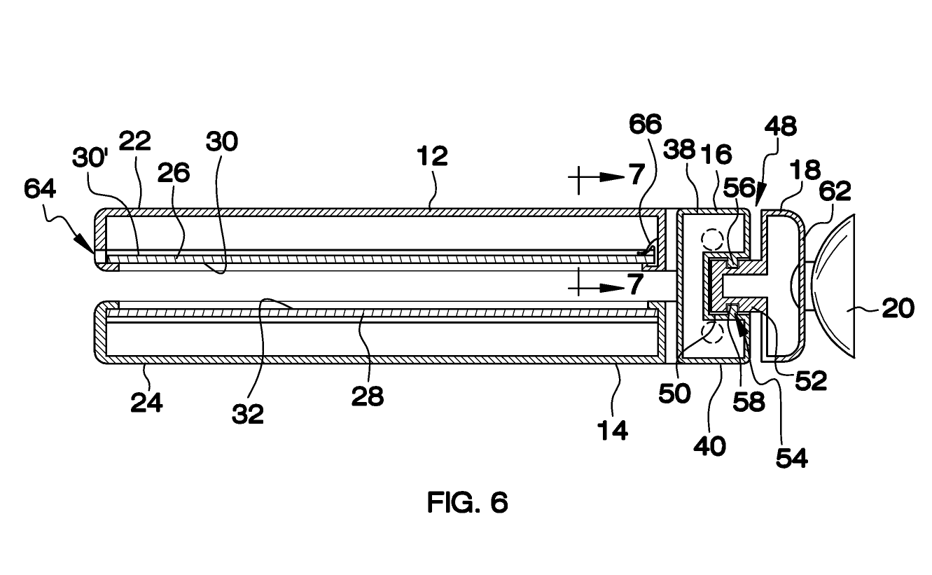

With particular reference to FIG. 6, an exemplary means for attaching the coupling member 16 to the base member 18 for rotation is illustrated. In this example, the coupling member 16 may be rotatably attached to and supported by the base member 18 by a post-in-socket coupling 48. The socket portion 50 may be defined by the coupling member 16 for rotatably receiving a post 52 that may project outwardly from the base member 18 at a forward surface. The post 52 may be captivity held in the socket 50 by a retaining means 54. While the retaining means 54 is shown herein has a circumferential ridge 56 projecting from an inner wall of the socket and received by a circumferential groove 58 formed around the post, the retaining means can include any structure or method which would prevent the withdrawal of the post from the socket once inserted therein. Additionally, as opposed to the arrangement above, the socket 50 may be defined by the base member 18 and the post 52 may be defined by the coupling member 16.

The base member 18 may be removably attached to a vertical support surface 100, such as, for example, a typical bathroom wall mirror by one or more attachment members 20. The one ore more attachment members 20 may be attached to a rearward surface 62 of the base member 18 and may also be longitudinally spaced therealong. Each of the one or more attachment members 20 may be a suction cup, adhesive tape or the like.

Now with particular reference to FIGS. 1, 6 and 7, one of the mirror elements 26 may have a second reflective surface 30′ opposite of the first reflective surface 30 that is magnifying. The mirror element 26 may be removably insertable into the housing 22 through a slot 64 located along one edge of the housing. In this manner, a user can remove and replace the mirror element 26 through slot 64 with the desired reflective surface 30 or 30′ facing outward of the housing 22. The mirror element 26 may be removably retained in the housing 22 by one or more spring elements 66 which urge against the mirror element to retain it in place.

Additionally, the mirror apparatus 10 or one or both mirror elements 26, 28 may be illuminated by any method known in the art. A description of one or more of the numerous possible methods is provided in U.S. Pat. No. 7,090,378 and U.S. Pat. No. 7,048,406, which the entirely of both are incorporated herein by reference.

In use, it can now be understood, the mirror apparatus 10 is removably attached to a vertical support surface, such as a bathroom wall mirror, at an elevation such that when positioned in the first configuration, the mirror members 12, 14 can be swung open and adjusted such that the reflective surface 30, 32 of the lower disposed mirror member 12, 14 is at least partially below the user's chin in order to reflect an image of the underside of the user's chin on to the reflective surface of the upper disposed mirror for viewing by the user while maintaining a generally forward facing view, as illustrated in FIG. 4. The mirror apparatus 10 can also be positioned in the second configuration with the mirror members 12, 14 disposed generally vertical and adjusted to permit viewing of either side of the user's face, as illustrated in FIG. 5.

A number of embodiments of the present invention have been described.

Nevertheless, it will be understood that various modifications may be made without departing from the spirit and scope of the invention. Accordingly, other embodiments are within the scope of the following claims.

I claim:

1. A mirror apparatus for grooming facial hair enabling a user to view an underside portion of the user's chin when positioned in a first configuration, and enabling a user to view both side portions of a user's face when positioned in a second configuration, the shaving mirror apparatus being compact, readily portable and removably attachable to a vertical surface, such as a bathroom mirror, the mirror apparatus comprising:
a base member having a longitudinal axis extending between opposed ends thereof;
a first mirror member, said first mirror member having a reflective surface and a first marginal edge portion;
a second mirror member, said second mirror member having a reflective surface and a first marginal edge portion;
coupling means for pivotally connecting said first marginal edge portions of said first and said second mirror members together for relative swinging between open positions with said reflective surfaces defining an angle therebetween and closed positions with said reflective surfaces disposed in a parallel and juxtapose relation;
rotation means for connecting said first and said second mirror members at first marginal edge portions to said base member for rotation about an axis normal to said longitudinal axis of said base member between a first configuration where said reflective surfaces are generally horizontal and a second configuration where said reflective surfaces are generally vertical; and
one or more attachment members for removably attaching said base member to a support surface, said attachment member connected to said base member.

2. A mirror apparatus for grooming facial hair enabling a user to view an underside portion of the user's chin when positioned in a first configuration, and enabling a user to view both side portions of a user's face when positioned in a second configuration, the shaving mirror apparatus being compact, readily portable and removably attachable to a vertical surface, such as a bathroom mirror, the mirror apparatus comprising:
a base member having a longitudinal axis extending between opposed ends thereof;
a coupling member;
a first mirror member, said first mirror member having a reflective surface and a first marginal edge portion;
a second mirror member, said second mirror member having a reflective surface and a first marginal edge portion;
said first and said second mirror members are pivotally attached at said first marginal edge portions to said coupling member for relative swinging between open positions with said reflective surfaces defining an angle therebetween and closed positions with said reflective surfaces disposed in a parallel and juxtapose relation;
said coupling member attached to said base member for rotation about an axis normal to said longitudinal axis of said base member between a first configuration where said reflective surfaces are positioned generally horizontal, and a second configuration where said reflective surfaces are positioned generally vertical; and
one or more attachment members for removably attaching said base member to a support surface, said one or more attachment members being attached to said base member.

3. The apparatus of claim 2, wherein said coupling member includes opposed longitudinal edges, and wherein said first mirror member is pivotally attached at a first longitudinal edge and said second mirror member is pivotally attached at the other longitudinal edge.

4. The apparatus of claim 3, wherein said coupling member is attached to a forward facing surface of said base member, and wherein said one or more attachment members are attached to a rearward facing surface of said base member.

5. The apparatus of claim 4, comprising two longitudinal spaced attachment members

6. The apparatus of claim 1, wherein each of said first and said second mirror members include a second marginal edge portion, which swing toward and away from each other as said first and said second mirror members are swung between said open and closed positions.

7. The apparatus of claim 2, wherein each of said first and said second mirror members define a housing, and said reflective surfaces are defined by mirror elements mounted within said housings with said reflective surfaces facing outwardly of said housings.

8. The apparatus of claim 7, wherein each of said housings are generally rectangular shaped.

9. A mirror apparatus for grooming facial hair enabling a user to view an underside portion of the user's chin when positioned in a first configuration, and enabling a user to view both side portions of a user's face when positioned in a second configuration, the shaving mirror apparatus being compact, readily portable and removably attachable to a vertical surface, such as a bathroom mirror, the mirror apparatus comprising:
a base member having rearward facing surface, a forward facing surface, and a longitudinal axis extending between opposed ends thereof;
a coupling member having opposed longitudinal edges;
a first mirror member, said first mirror member having a reflective surface and a first marginal edge portion;
a second mirror member, said second mirror member having a reflective surface and a first marginal edge portion;
said first mirror member is pivotally attached at said first marginal edge portion thereof to a first longitudinal edge of said coupling member and said second mirror member is pivotally attached at said first marginal edge portion thereof to the opposite longitudinal edge of said coupling member for relative swinging between open positions with said reflective surfaces defining an angle therebetween and closed positions with said reflective surfaces disposed in a parallel and juxtapose relation;
said coupling member attached to said forward facing surface of said base member for rotation about an axis normal to said longitudinal axis of said base member between a first configuration where said reflective surfaces are positioned generally horizontal, and a second configuration where said reflective surfaces are positioned generally vertical; and
one or more attachment members for removably attaching said base member to a support surface, said one or more attachment members being attached to said rearward facing surface of said base member.

10. The apparatus of claim 9, wherein each of said first and said second mirror members define a housing, and said reflective surfaces are defined by mirror elements mounted within said housings with said reflective surfaces facing outwardly of said housings.

11. The apparatus of claim 9, wherein said forward facing surface of said base member defines a post that projects outwardly therefrom along the axis normal to said longitudinal axis, and wherein a rearward facing surface of said coupling member defines a socket along the axis normal to said longitudinal axis and which rotating and captively receives said post so as to rotatably attach said coupling member to said base member.
